(19) United States
(12) Patent Application Publication
(10) Pub. No.: US 2008/0081682 A1
(43) Pub. Date: Apr. 3, 2008

(54) CARD GAMING MACHINE WITH PLURAL TERMINALS AND CARD GAMING METHOD THEREOF

(75) Inventor: Kazumasa YOSHIZAWA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 11/862,829

(22) Filed: Sep. 27, 2007

(30) Foreign Application Priority Data
Oct. 3, 2006 (JP) 2006-271546

(51) Int. Cl. A63F 13/00

(52) U.S. Cl. 463/11; 463/43

(57) ABSTRACT

A gaming environment, in which a game is executed by controlling plural terminals to which inputs from players are received, and an award is provided based on the player's cards distributed to the terminal, is described. Especially a gaming environment, in which a game is executed by allocating one card deck to each of the terminals, is described.

### CROSS-REFERENCE TO RELATED APPLICATIONS

This application is based upon and claims a priority from the prior Japanese Patent Application No. 2006-271546 filed on Oct. 3, 2006, the entire contents of which are incorporated herein by reference.

### BACKGROUND

1. Field

The present invention relates to a multiplayer card gaming machine and a card game playing method, in which a game is executed by controlling plural terminals to which inputs from players are received, and an award is provided based on the player's cards distributed to the terminal, especially relates to a multiplayer card gaming machine and a card game playing method, in which a game is executed by allocating one card deck to each of the terminals.

2. Description of Related Art

Conventionally, card gaming machines or card gaming tables for playing card games such as Pai Gow Poker or Draw Poker or Blackjack are arranged in a casino or a game arcade. Here, in above card games, the game is processed by using the cards with marks (for example, “Heart A”). An award is provided to a player based on a hand of the cards corresponding to a player and a hand of the cards corresponding to a dealer.

Here, the Pai Gow Poker is a game in which seven cards are distributed to a dealer and plural players (maximum is 6) respectively, and seven cards distributed to a dealer and each player are allocated into 2 sets, one set of 2 cards and one set of 5 cards, and then the hand of the cards corresponding to each set, is compared with each other to determine the game result and the content of an award.

### SUMMARY

In view of the foregoing, one or more aspects of the present invention relate to a gaming machine, a gaming method thereof, a game system, a computer readable medium having computer-executable instructions or the like that it is possible to provide a chance to each player who wants to participate in the game, without setting a limit to the number of the players.

One or more of the above aspects of the invention is more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is an explanatory view showing an allocating method of card decks according to the embodiment.

FIG. 2 is an outline view of a card gaming machine according to the embodiment.

FIG. 3 is an outline view of a terminal according to the embodiment.

FIG. 4 is a block diagram schematically showing a control system of the card gaming machine according to the embodiment.

FIG. 5 is a block diagram schematically showing a control system of the terminal according to the embodiment.

FIG. 6 is an explanatory view showing a betting image displayed on the liquid crystal display of the terminal according to the embodiment.

FIG. 7 is an explanatory view showing a betting image displayed on the liquid crystal display of the terminal according to the embodiment.

FIG. 8 is an explanatory view showing the backside images of a card deck according to the embodiment.

FIG. 9 is an explanatory view showing a main screen displayed on the front display according to the embodiment.

FIG. 10 is a flowchart of a game processing program in the card gaming machine according to the embodiment.

FIG. 11 is a flowchart of a game processing program in the card gaming machine according to the embodiment.

FIG. 12 is an explanatory view showing an example of a table game in which the present invention is applied.

### DETAILED DESCRIPTION

The various aspects summarized precedingly may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention is described in detail with reference to the drawings based on an embodiment embodying one or more aspects of the invention as a card gaming machine, a server, a game system. However, it is appreciated that one or more aspects of the present invention may be embodied in distributable (via CD and the like) or downloadable software games, console games, and the like. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Hereinafter, concerning with a card gaming machine which is used in a multiplayer card gaming equipment according to the present invention, the embodiment embodying the present invention is described in detail with reference to the drawings. Here, the card gaming machine according to the embodiment, is one type of the multiplayer gaming machine with plural terminals, wherein the terminals receive inputs from plural players. The game executed is the Pai Gow Poker, one kind of the card games. Here, the Pai Gow Poker is a kind of game, in which each player bets predetermined tips, seven cards distributed as the player's hand are allocated into two sets of 5 cards (high hand) and 2 cards (second hand). High hand and second hand of the player's cards may be compared with those of dealer's cards, wherein the dealer's cards are the hand of dealer. If both high hand and second hand of player are higher than those of dealer, it is determined that the player is the winner, the award corresponding to the betted amount may be paid out.

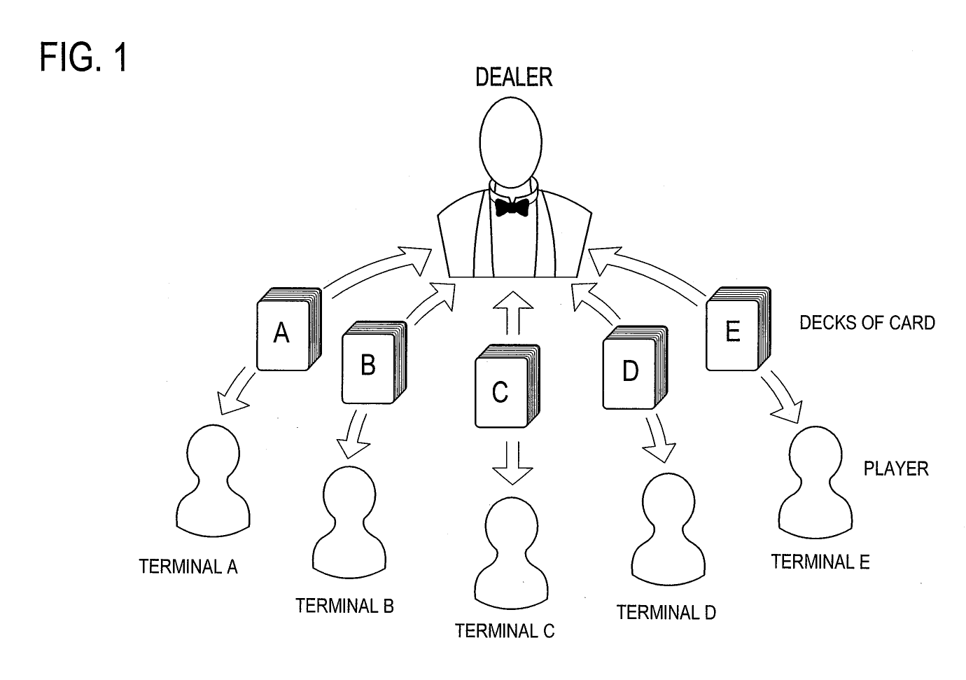

In the conventional card gaming machine only one card deck is used for plural terminals in each of which the player conducts input operation. Contrarily, in the card gaming machine of the embodiment, as especially shown in FIG. 1, even if plural players participate in the game and game is executed by them, each of plural card decks A-E different from each other is allocated to each of the terminals A-E. And the dealer's cards and the player's cards are pulled out and distributed from each allocated card deck A-E respectively. In other words, one card deck may be allocated to each player who participates in the game respectively, and the game is executed thereafter.

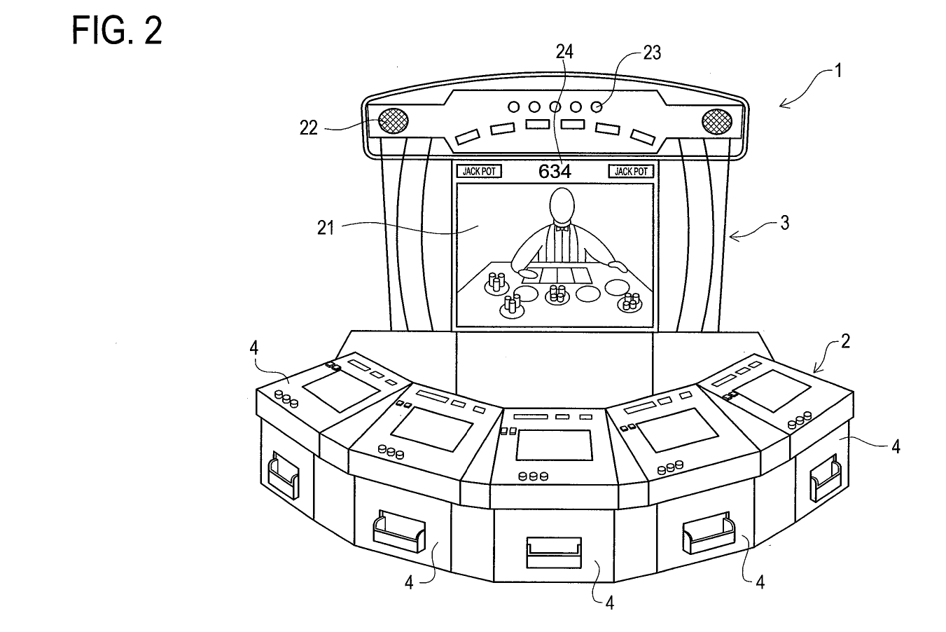

First, an outline construction of the card gaming machine 1 according to the embodiment is described with reference to FIG. 2. FIG. 2 is a perspective view of the card gaming machine 1 according to the embodiment.

The card gaming machine 1 according to the embodiment is basically constructed from a table deck 2 and a panel portion 3. The table deck 2 is a place where players may be seated and play a game, and the panel portion 3, which is arranged behind the table deck 2, displays animation images of a virtual dealer.

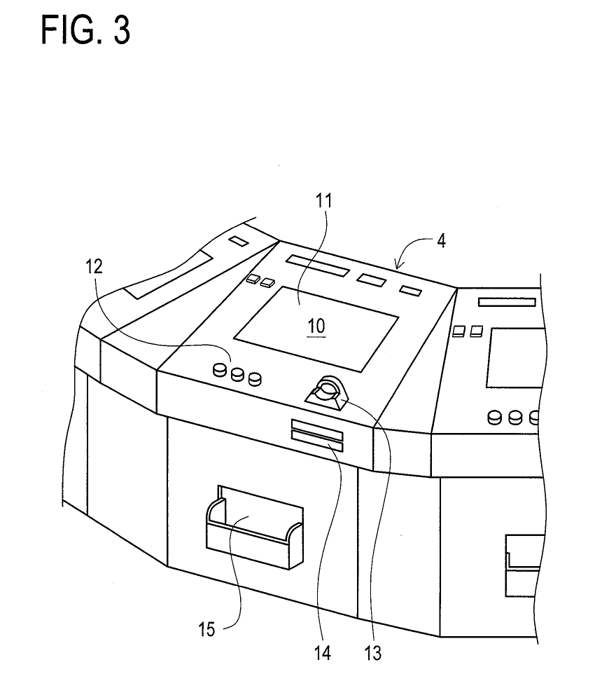

Hereinafter, the table deck 2 is described first. The table deck 2 has several (there are 5 in FIG. 2) player terminals 4 called satellites which are arranged in a fan-like shape. Here, FIG. 3 is a perspective view of one of the player terminals 4 according to the embodiment.

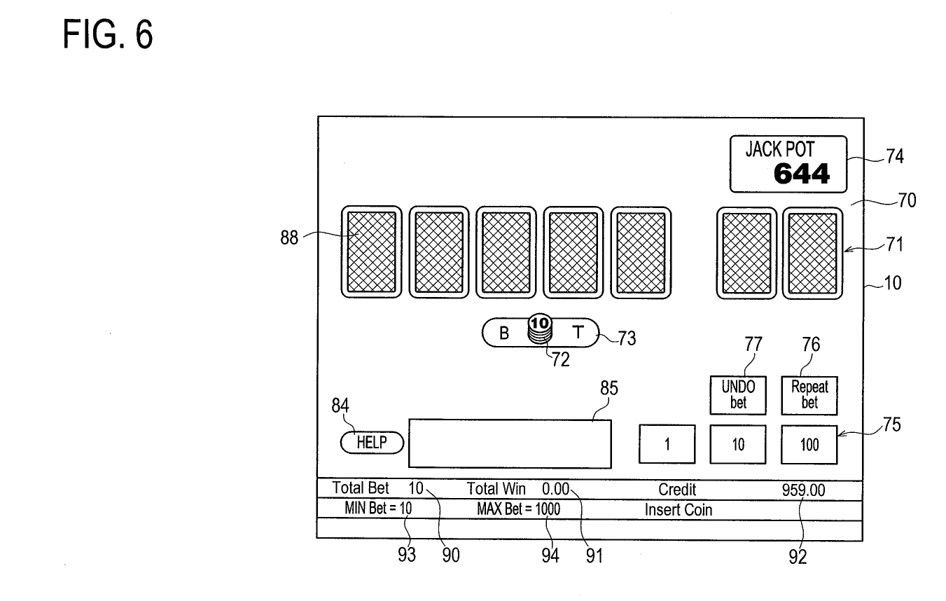

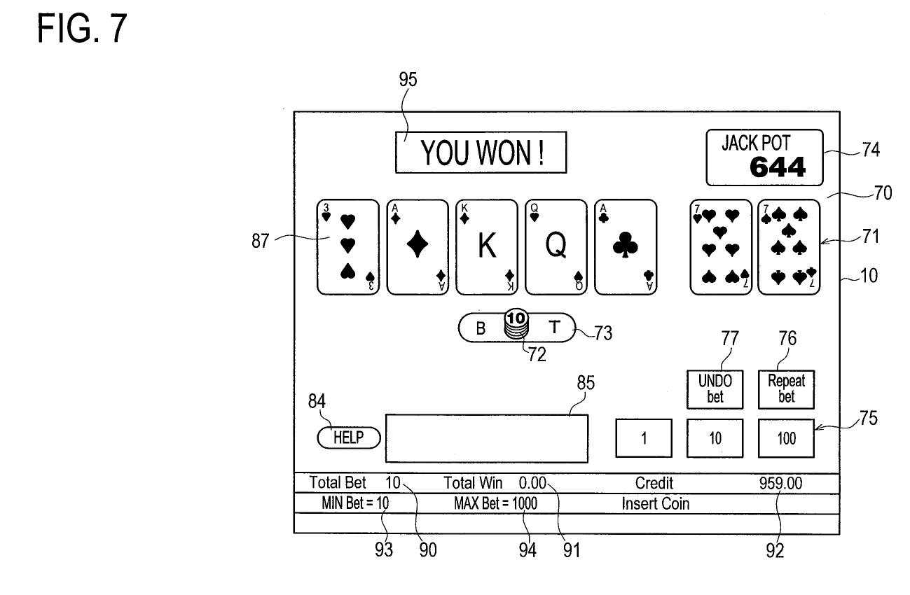

As shown in FIG. 3, the player terminal 4 is constructed from a liquid crystal display 10, a touch panel 11, operating buttons 12, a coin insertion slot 13, a bill insertion portion 14, and a coin payout opening 15. The liquid crystal display 10 is used to display the betting image (described below, see FIG. 6 and FIG. 7) or the game results. The touch panel 11, is arranged on the front plane of the liquid crystal display 10 and is used to select buttons displayed on the liquid crystal display 10 when betting subjects are selected and the bet amount is set. The operating button 12 is a button to execute operations such as payout operation. The coin insertion slot 13 is a slot to insert coins or medals. The bill insertion portion 14 is an insertion portion for inserting bills. And the coin payout opening 15 is an opening to pay out coins or medals corresponding to the credits stored when payout operation is executed.

And the panel portion 3 is constructed from a front display 21, speakers 22, and LEDs (light emitting diode) 23. The front display 21 is used to display images of a dealer and the content of cards distributed, wherein a dealer is a person who distributes cards or receives tips in the card game. The speakers 22, which are arranged above the front display 21, may output music and effect sounds according to the progress of the game. And LEDs 23 are lightened when various stages are shown.

A JACKPOT amount display portion 24 is formed at an upper portion of the front display 21. Here, for the card gaming machine 1 according to the embodiment, 5% of the betted amount betted by a player is pooled in the POT. Under a condition that a hand of the player's card is a specific hand (for example, high hand becomes to a Royal Flush hand), the player gets the winning lottery of JACKPOT, therefore the pooled amount is paid out in a lump. And the JACKPOT amount display portion 24 is a portion to display the pooled amount in the POT until now.

Here, cards used in the card gaming machine 1 according to the embodiment, which are same as trump cards generally used, are displayed with the “marks” consist of “suits” and “numbers” (see FIG. 7).

Here, “Suits” are the marks of the trump cards. There are 4 kinds of “suits” including spade, heart, diamond and club.

And “numbers” indicate numbers or English Characters in trump cards. There are 13 kinds of numbers or English Characters, which are A (Ace, equivalent to 1), 2, 3, 4, 5, 6, 7, 8, 9, 10, J (Jack, equivalent to 11), Q (Queen, equivalent to 12), K (King, equivalent to 13).

And “marks” indicate the types of cards which are determined by combinations of “suits” and “numbers”, for an instance, “Heart A”, “Spade K”. A total of fifty-three cards is defined as a single card deck. Fifty-three cards includes a joker and a total of fifty-two cards, wherein fifty-two cards consist of 13 kinds of numbers for each of the 4 kinds of suits necessary in a card game.

Next, the playing method of the card gaming machine 1 according to above construction will be explained. Players playing a game may be seated before the player terminal 4. Players may bet a desired betting amount with a betting screen displayed on the liquid crystal display 10. The images of cards distributed to players and a dealer respectively are displayed on the front display 21 and each liquid crystal display 10. An operation of allocating high hand and second hand is executed. A performance image of a player or a dealer as a winner, or an image for draw between the dealer and player is displayed, based on kinds of card marks allocated as high hand and second hand. Furthermore, at each terminal 4, under a condition that a player wins the game against the dealer, double credits of the betted amount is provided as an award. However, when a player loses the game against the dealer, no award is provided. And when a player plays to a draw with the dealer, the betted amount is returned to the player. And when a player's high hand becomes to Royal Flush (a hand including the same kinds of suits with “10”, “J”, “Q”, “K”, “A”), the player gets the winning lottery of JACKPOT, and the pooled amount pooled in the POT until now is paid out in a lump.

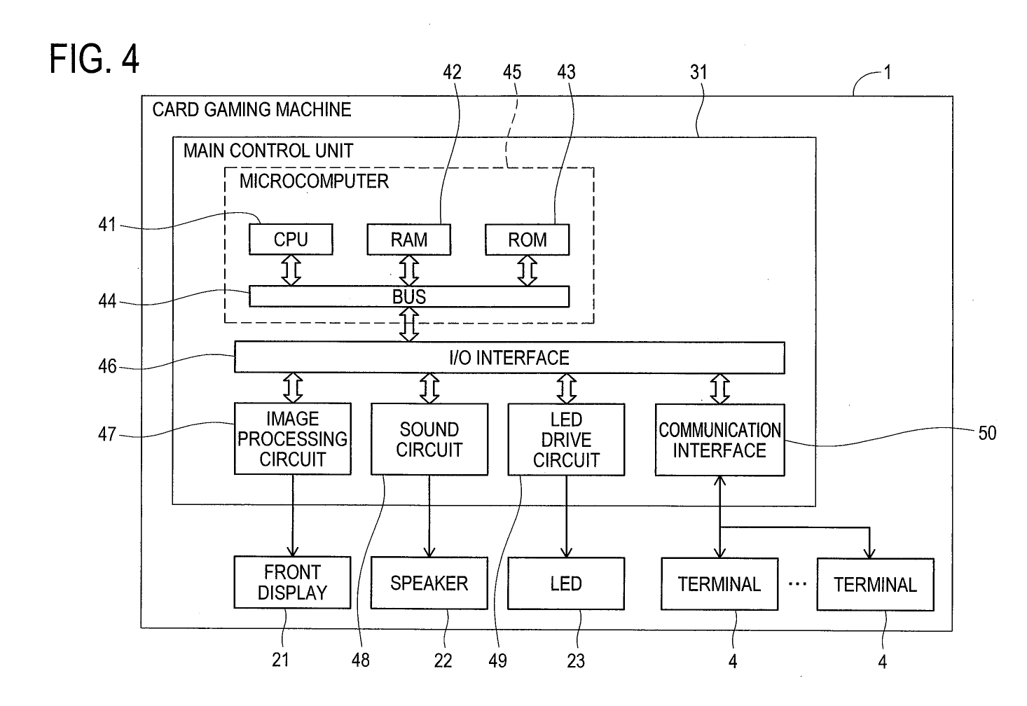

Next, a construction of a control system in the card gaming machine 1 is described with reference to FIG. 4. FIG. 4 is a block diagram schematically showing a control system of the card gaming machine 1 according to the embodiment.

As shown in FIG. 4, the card gaming machine 1 according to the embodiment is constructed from a main control unit 31, plural player terminals 4 which are connected to the main control unit 31, and a variety of peripheral devices.

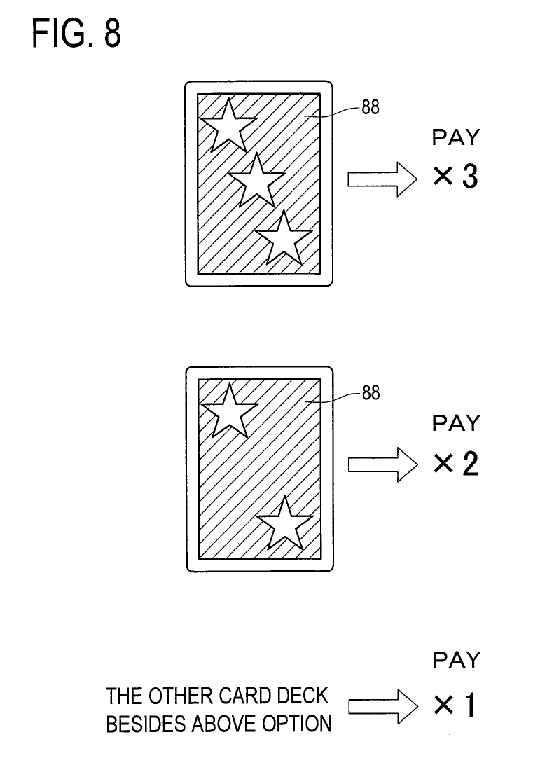

The main control unit 31 includes a microcomputer 45 as a core. And the microcomputer 45 includes a CPU 41, a RAM 42, a ROM 43, and a bus 44 for transmitting data among the CPU 41, the RAM 42, the ROM 43. In the ROM 43, various programs necessary for executing processes to control the card gaming machine 1 and data tables are stored. The RAM 42 is a memory to temporarily store various data calculated by the CPU 41. And in the ROM 43, front and backside image data of the cards distributed to the player and the dealer are also stored. In the card gaming machine 1 according to the embodiment, as described below, one card deck is allocated to each terminal 4 to execute games, each allocated card deck consists of the backside image in different design (see FIG. 8). Therefore, in the ROM 43, the backside image data corresponding to the numbers of card decks utilized in the game, are stored.

And to the CPU 41, an image processing circuit 47 is connected through an I/O interface 46. And a sound circuit 48, a LED drive circuit 49 and a communication interface 50 are also connected to the CPU 41.

Furthermore, the main control unit 31 is a unit to determine whether game start conditions are satisfied after receiving the betting operation information by a player, such as betted amount, from each player terminal 4. If a game starts, seven cards from the fifty-three trump cards are distributed to a player and a dealer respectively according to the lottery result (on the screen, cards are distributed to a player and a dealer respectively). Game result (one of the results including winning of a player, winning of a dealer and draw between a player and a dealer) is determined according to the hands of the cards distributed. And the game result is transmitted to each player terminal 4. Thereafter, each player terminal 4 may increase or decrease the credits stored according to the game result received from the main control unit 31.

The main control unit 31 also outputs signals of images displayed on the front display 21, and executes drive control of speakers 22 and LEDs 23.

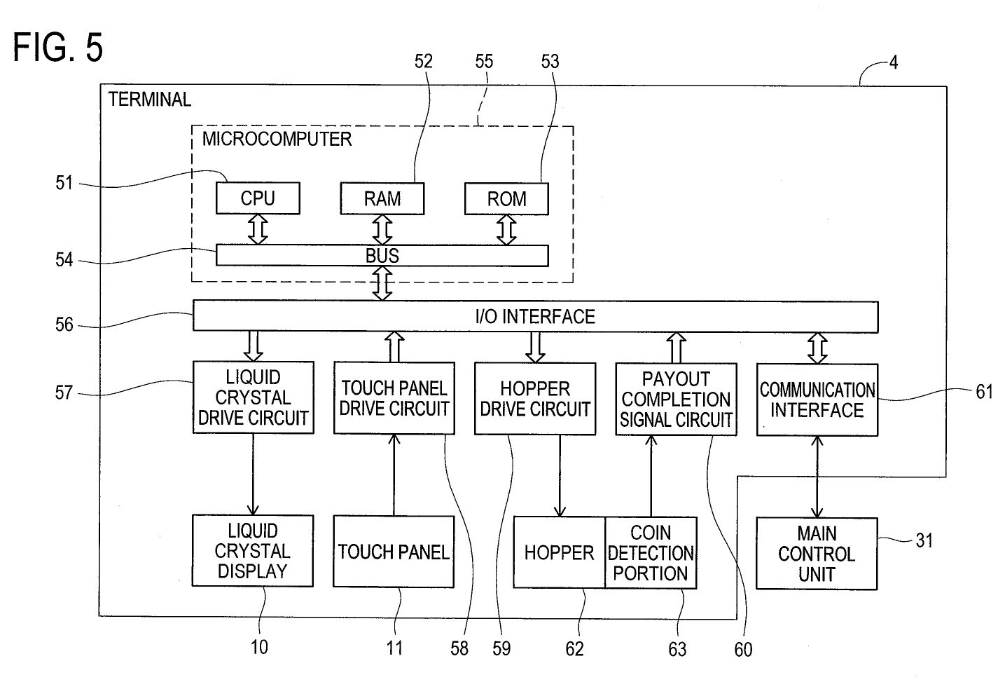

Next, a construction of a control system in a player terminal 4 is described with reference to FIG. 5. FIG. 5 is a block diagram schematically showing a control system of a player terminal 4 according to the embodiment.

As shown in FIG. 5, the player terminal 4 according to the embodiment includes a microcomputer 55 as a core. And the microcomputer 55 includes a CPU 51, a RAM 52, a ROM 53, and a bus 54 for transmitting data among the CPU 51, the RAM 52, the ROM 53 and the bus 54. In the ROM 53, various programs and data tables are stored. The various programs are the programs for executing the processes necessary to control the player terminal 4. The RAM 52 is a memory to temporarily store the credits currently stored in a player terminal 4, the betting subjects on which players made bet, and the betted amount (credits) which are betted on the betting subjects, and various data calculated by the CPU 51.

And to the CPU 51, a liquid crystal panel drive circuit 57, a touch panel drive circuit 58, a hopper drive circuit 59, a payout completion signal circuit 60 and a communication interface 61 are connected through an I/O interface 56. Furthermore, the liquid crystal display 10 and the liquid crystal panel drive circuit 57, the touch panel 11 and the touch panel drive circuit 58, the hopper 62 and the hopper drive circuit 59, the coin detection portion 63 and the payout completion signal circuit 60, are connected, respectively.

The betted amount (credits) which are betted by a player is calculated by the CPU 51 according to the output operation information from touch panel 11, and is stored in the betted amount memory area 52A of the RAM 52, and also is transmitted to the main control unit 31. Additionally, the credits stored are increased or decreased by the CPU 51 based on the game result transmitted by the main control unit 31.

The CPU 51 may also output the signals of images displayed on the front display 21, and may control the coin payout from the coin payout opening 15 based on the signals of the hopper 62 and the coin detection portion 63.

Next, the betting image 70 displayed on the liquid crystal display 10 of a player terminal 4, when Pai Gow Poker game is played on the card gaming machine 1 according to the embodiment, is described with reference to FIG. 6 and FIG. 7.

FIG. 6 and FIG. 7 are explanatory views of the betting image 70 displayed on the liquid crystal display 10 of the player terminal 4. Here, in the card gaming machine 1 according to the embodiment, the player makes bet of predetermined credits by touching the betting image 70 and the touch panel 11. And operations for allocating cards into high hand and second hand may also be executed.

As shown in FIG. 6 and FIG. 7, the betting image 70 is constructed from a player card display area 71, a tip display area 73, a pooled amount display area 74, and an information display area. The player card display area 71 may display the front image 87 and the backside image 88 of the cards distributed to a player. The tip display area 73 may display the tip image 72 which is betted, and the pooled amount display area 74 may display the pooled amount which is pooled in the POT, the information display area is an area to display various operation buttons and information of the player.

Here, the player card display area 71 is an area to display the front image 87 and the backside image 88 of the cards distributed to the player. The player's cards are firstly displayed with the backside image 88 right after being distributed to the player, in which marks of the cards can not be recognized (see FIG. 6). And then the front image 87 is displayed as the marks can be recognized (see FIG. 7). The front image 87 and the backside image 88 of the seven cards displayed in the player card display area 71, are the images of the cards distributed to the player seated on the terminal 4. And also the player's cards may be allocated freely into a high hand with 5 cards and a second hand with 2 cards, within the range in accordance to a house rule.

Especially in FIG. 6 and FIG. 7, the 5 cards located at the left side of the betting image 70 are the cards sorted as the high hand, the 2 cards on the left side of the betting image 70 are the cards sorted as the second hand. The selection of high hand and second hand may be changed by a player through the touch panel 11 to change the allocation of the seven cards displayed in the player card display area 71.

In the card gaming machine 1 according to the embodiment, one card deck is allocated to each of the five terminals 4, and distribution of the cards for players and the dealer is executed from the allocated card deck. Accordingly a maximum of five card decks may be used in the embodiment.

Furthermore, each of the five card decks may be equipped with the backside images 88 in different design. Under a condition that a terminal 4 is allocated with the card deck which contains cards with the backside image 88 of a specific design as shown in FIG. 8, the amount of the winning award is increased to 3 or 2 times.

When a card deck which contains the backside image 88 of a specific design is allocated to a terminal 4, an award of a predetermined amount (for example, 100 credits) may be paid out other than increasing the amount of an award. Furthermore, when a card deck containing the backside image 88 with the word “JP” is allocated to a terminal 4, the terminal 4 wins the lottery of JACKPOT, the amount pooled in the POT may also be provided to the terminal 4.

The image 72 of the tips which are equal to the betted amount betted by the player may be displayed in the tip display area 73 (for example, in FIG. 6 and FIG. 7, tips of 10 credits are betted). A player may select the betted amount by pressing the after-mentioned betting button 75, and may decide the betting amount by touching the tip display area 73, and the decided betting amount is transmitted to the main control unit 31.

The pooled amount display area 74 is an area to display the pooled amount which is pooled in the POT. Here, in the card gaming machine 1 according to the embodiment, 5% of the betted amount betted by the player is pooled in the POT.

On the right lower portion of the tip display area 73, betting buttons 75 are arranged (in the embodiment, there are three kinds of the betting buttons, which are “1 credit”, “10 credits”, “100 credits”). The player may select the betted amount to bet in the game by touching the betting button 75.

Above the betting button 75, a REPEAT betting button 76 and an UNDO betting button 77 are formed. The player may bet the same betted amount as betted in the preceding game by pressing the REPEAT betting button 76. And the player may cancel the betting operation which is once conducted by pressing the UNDO betting button 77.

On the left lower portion of the tip display area 73, a HELP button 84 is arranged. The HELP button 84 is a button to be pressed when the player wants to display the operation methods of the card gaming machine 1 on the liquid crystal display 10. On the right side of the HELP button 84, a message area 85 which shows the message supporting the game process is arranged.

On the lower portion of the betting image 70, a betted amount display area 90, an acquisition amount display area 91, a possessed credits display area 92, a minimum betting amount limit display area 93 and a maximum betting amount limit display area 94 are arranged. The betted amount display area 90 shows the betted amount betted by the player for the current game, the acquisition amount display area 91 shows the acquisition amount which the player acquired as awards in the game until now, the possessed credits display area 92 shows the credits which the player possessed currently, the minimum betting amount limit display area 93 shows the minimum limit which the player may possibly bet, and the maximum betting amount limit display area 94 shows the maximum limit which the player may possibly bet.

And a game result display area 95, which shows the result of the current game between the player and the dealer, is arranged on the left side of the player card display area 71. Here, in the Pai Gow Poker game, if both the high hand and the second hand of a player are higher than those of the dealer, the player wins the game. If either the high hand or the second hand of a player is higher than that of the dealer, the player plays to a draw with the dealer. And when it ends in a draw, the word of “DRAW” is displayed on the game result display area 95. And when the player wins the game, the words of “YOU WON” are displayed on the game result display area 95. And if the player loses the game, the words of “YOU LOST” are displayed on the game result display area 95.

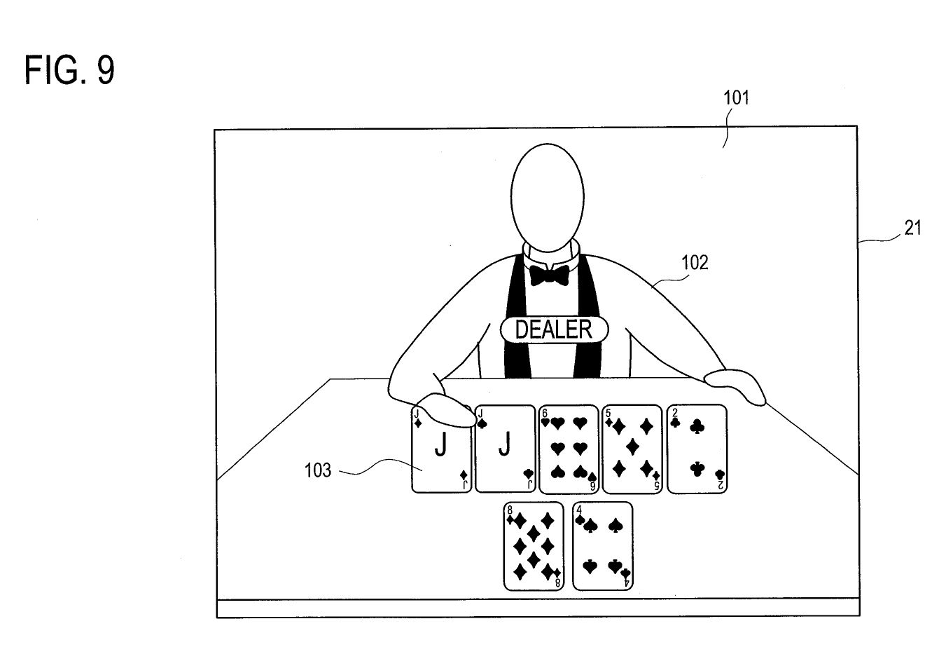

Next, a main screen 101 which is displayed on the front display 21, when the Pai Gow Poker game is played on the card gaming machine 1 according to the embodiment, will be described with reference to FIG. 9.

FIG. 9 is an explanatory diagram of the main screen 101 which is displayed on the front display 21. Here, in order to raise the realistic sensation of the game in the card gaming machine 1 according to the embodiment, a dealer's image 102, in which animations such as card distribution along with the game are executed, is displayed on the main screen 101.

Almost on the center portion of the main screen 101, a card image 103 is displayed to show the cards distributed to the dealer. Here, in the card gaming machine 1 according to the embodiment, seven cards are also distributed to the dealer as dealer's cards. And the dealer's cards are also divided into high hand and second hand in accordance with the house rule. And both the high hand and second hand are displayed on the main screen 101 (for example, in FIG. 9, 5 cards of high hand are displayed on an upper stage, and 2 cards of second hand are displayed on a lower stage).

In the card gaming machine 1 according to the embodiment, one card deck is allocated to each terminal 4 as mentioned before, while the dealer cards are the same to each terminal 4. In other words, from each card deck, seven cards are pulled out as dealer's cards. And then from the remained forty-six trump cards, player's cards are distributed to each terminal 4.

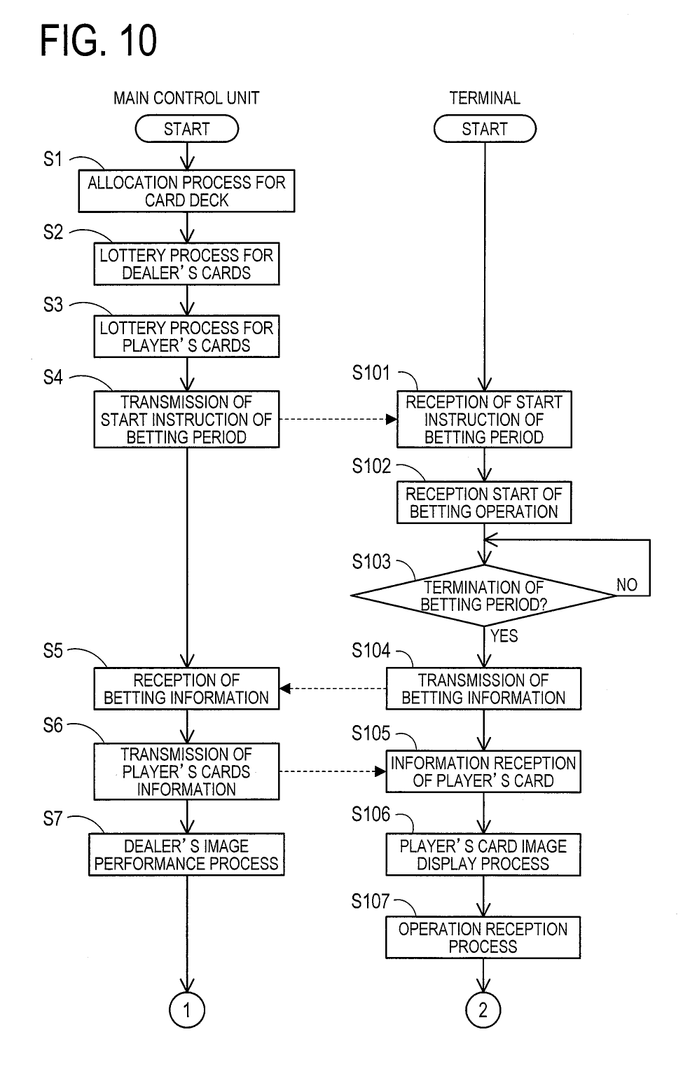

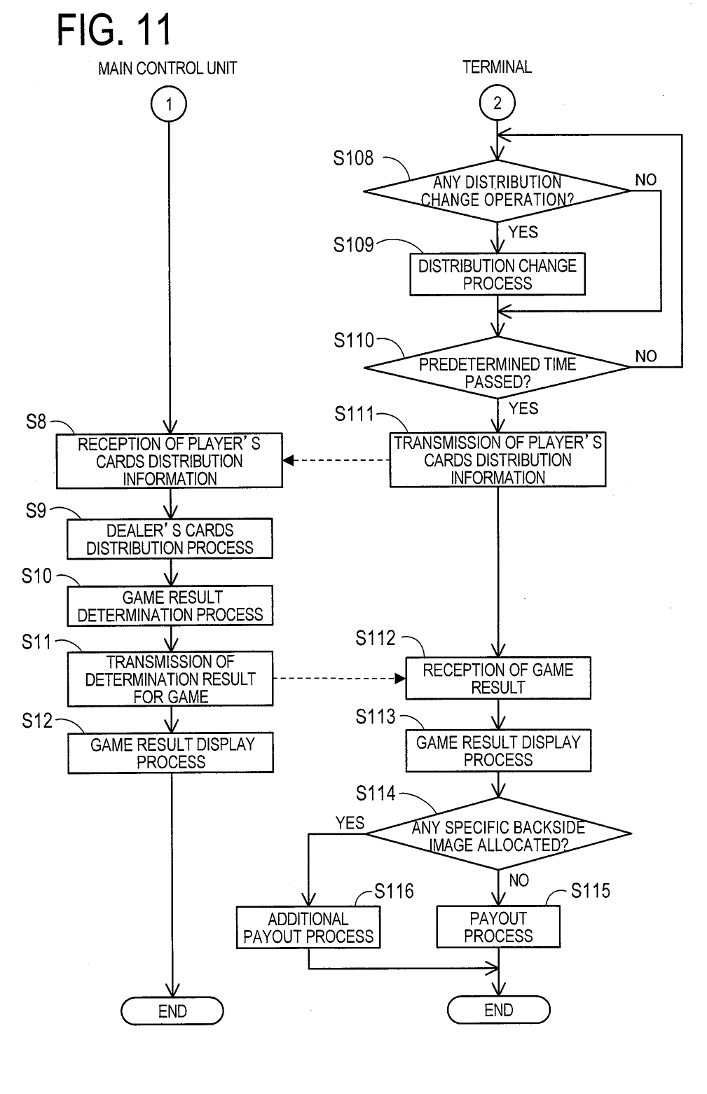

Next, in the card gaming machine 1 with above construction, a game processing program executed by the CPU 41 of the main control unit 31, and a game processing program at the terminal 4 executed by the CPU 51 of the player terminal 4 will be explained with reference to FIG. 10 and FIG. 11. The programs flowcharted in FIG. 10 and FIG. 11, are stored in the RAM 42 or the ROM 43 of the main control unit 31, or in the RAM 52 or the ROM 53 of the player terminal 4, and are executed by the CPU 41 or the CPU 51.

First, the game processing program executed by the main control unit 31 will be explained with reference to FIG. 10 and FIG. 11. In step (abbreviated as “S” hereinafter) 1, five card decks are determined by the CPU 41 and each of them is allocated to each terminal 4, based on a lottery process. Here, for each allocated card deck, the front image displaying the marks are in common, however, the backside images are different. If a card deck containing the backside image 88 of a specific design is allocated to a terminal 4, the award mentioned later is increased than that in a usual case (S115).

Hereinafter, in S2, a lottery process for dealer's cards is executed by the CPU 41 to sort the dealer's cards. Concretely, if a card deck used in a game contains N cards (in a Pai Gow Poker game, N=53), either number of 1˜N is associated to each card constructing the card deck allocated to each terminal 4. And in S2, 7 numbers are sorted out from the numbers of 1N, the seven cards associated with the 7 sorted numbers become the dealer's cards (the cards which are distributed to the dealer).

Next, in S3, from the card deck allocated to each terminal 4 in preceding S1, the player's cards may be sorted out by the CPU 41 via lottery process for player's cards. Concretely, from the fifty-three cards constructing each card deck, forty-six cards may be remained after seven cards are sorted out as the dealer's cards in S2. To these remained forty-six cards, either number of 1˜46 (distribution order) is associated with each card. And then seven numbers are sorted out from the numbers of 1˜46 for each of the five card decks. And the seven cards associated with the seven sorted numbers become the player's cards of each terminal 4 (the cards which are distributed to players).

Thereafter, in S4, the start instruction of betting period, in which the reception of the betting operation is executed by players, is transmitted to each terminal 4 by the CPU 41.

Next, in S5, the betting information is received from each terminal 4 by the CPU 41. Here, the betting information includes information regarding to the betted amount (credits) which is betted by players. And the received betting information from each terminal 4 is stored in the RAM 42 temporarily.

In S6, information regarding to the player's seven cards which are distributed to players, is transmitted to each player terminal 4 by the CPU 41, based on the lottery result of the lottery process for distributing player's cards in preceding S3. Such information includes the information regarding to the marks such as “Heart 7” or “Spade A”, and the information relating to the backside image of the card deck allocated to each terminal 4. And in S7, the dealer's image, in which the dealer is distributing seven cards to each of players and the dealer, is displayed on the front display 21 as the main screen 101 (see FIG. 9). Meanwhile, regarding to the dealer's seven cards which are distributed to the dealer, the backside image is displayed when the cards are distributed. And the kinds of the marks are non-displayed at that time.

In S8, information regarding to the allocation of the cards into high hand and second hand is received by CPU 41 from each terminal 4. In the card gaming machine 1 according to the embodiment, 5 cards of high hand and 2 cards of second hand may be assigned freely by players in accordance with the house rule.

And then, in S9, dealer's seven cards sorted in preceding S2, may be allocated to high hand and second hand by the CPU 41 in accordance with the house rule. Furthermore, the image of the dealer's cards displayed on the main screen changes from the backside image to the front image, and the dealer's cards which are allocated into high hand and second hand are displayed (see FIG. 9).

In S10, the player's cards are compared with the dealer's cards by the CPU 41 for high hand and second hand respectively. Concretely, based on the hand of the cards, it is determined that if both the high hand and the second hand of the dealer are higher than those of a player, the dealer wins the game. It is also determined that if both the high hand and the second hand of a player are higher than those of the dealer, the player wins the game. In other case besides the above patterns, the player plays to a draw with the dealer. The kinds of the hands in a Pai Gow Poker game are in the public domain, it may be omitted here.

In S11, the game result determined in preceding S10 may be transmitted by the CPU 41 to each terminal 4. And in S12, the game result images showing the game results of each terminal 4, may be displayed on the main screen 101 of the front display 21.

Next, the game processing program executed by a terminal 4 will be explained with reference to the FIG. 10 and FIG. 11. In S101, the start instruction of the betting period is received by the CPU 51 from the main control unit 31.

In S102, the betting image 70 (see FIG. 6 and FIG. 7) is displayed on the liquid crystal display 10, and the betted amount (credits) which is betted based on the operation information from the touch panel 11 is specified, by the CPU 51.

Next, in S103, it is determined by the CPU 51 whether the betting period is terminated or not. Concretely, it is determined whether the predetermined time (for example, 20 seconds) has passed from the reception of the betting operation in the preceding S102.

If it is determined that the betting period has not passed (S103: NO), the reception of the betting operation may be continued by the CPU 51. On the contrary, if it is determined that the betting period has passed (S103: YES), procedure shifts to S104.

In S104, the betting information is transmitted by the CPU 51 to the main control unit 31. Here, the betting information includes the information regarding to the betted amount (credits) which the player has betted.

In S105, the card information regarding to the player's seven cards distributed to the terminal 4, is received by the CPU 51 from the main control unit 31 (information regarding to the marks, and the information relating to the backside images of the card deck allocated to each terminal 4). In S106, based on the card information received in S105, the player's seven cards are displayed on the betting image 70 by the CPU 51. And in S106, the player's cards may be firstly displayed via the backside image 88, in which the marks of the cards can not be distinguished (see FIG. 6). And after the predetermined time (for example, 3 seconds) has passed, the player's cards may be then displayed via the front image 87, in which the marks of the cards can be distinguished (see FIG. 7).

Thereafter, in S107, regarding to the player's cards displayed on the betting image 70, reception of the changeover operation on allocation of the high hand and second hand by players, may be started by the CPU 51. In S108, it is determined whether the changeover operation on allocation is executed or not. If it is determined that the changeover operation is executed (S108: YES), the kinds of cards may be changed by reallocating the cards into high hand and second hand, and the arrangement of the player's cards displayed on the betting image 70 may be switched over, by the CPU 51.

On the other hand, if it is determined that the changeover operation on allocation of high hand and second hand is not executed (S108: NO), procedure shifts to S110.

In S110, it is determined whether a predetermined time (for example, 15 seconds) has passed since the operation reception process starts in the preceding S107. If it is determined that the predetermined time has passed (S110: YES), the allocation information of the high hand and second hand of current player's cards, may be transmitted to the main control unit 31 (S111). If it is determined that the predetermined time has not passed (S110: NO), procedure shifts to S108. Next, in S112, the game result which is transmitted from the main control unit 31, is received by the CPU 51. And in S113, the game result of the player who is seated on the terminal 4, is displayed on the liquid crystal display 10 by the CPU 51, based on the game result transmitted in preceding S112. Concretely, on the game result display area 95 of the betting image 70 (see FIG. 7), the word “DRAW” is displayed when the player plays to a draw with the dealer. The words “YOU WON” are displayed when the player wins the game. The words “YOU LOST” are displayed when the player loses the game.

And then in S114, it is determined whether the card deck including the card with the specific backside image 88 is allocated to the terminal 4 by the CPU 51, based on the player's cards information received in preceding S104. Here, the specific backside image is the image like the backside image 88 shown in FIG. 8.

In S114, if it is determined that the card deck including the backside image other than the specific image is allocated (S114: NO), a normal payout may be executed. Concretely, when a player wins the game against dealer, the credits with a double of the betted amount are paid out to the player. When a player plays to a draw with the dealer, the betted amount may be returned to the player (S115).

If it is determined that the card deck including the specific backside image is allocated (S114: YES), the amount of the paid out award is changed from the case in S115, and the pay out is executed. Concretely, when a player wins the game against dealer, the credits with a double or a triple amount of the normal amount are paid out to players, corresponding to the design of the allocated backside image (S116).

Here, in the card gaming machine 1 according to the embodiment, under a condition that a player's cards include the Royal Flush, the pooled amount pooled in the POT until now is provided as an award. After the pooled amount is paid out, the pooled amount is updated to an initial value (for example, 100).

As explained above, in the card gaming machine 1 according to the embodiment and the playing method of the card game, one card deck may be allocated to each terminal (S1), the dealer's cards and the player's cards may be distributed from the allocated card deck, and the distributed dealer's cards and the player's cards may be compared via high hand and second hand to determine the game result (S10). If a player wins the game, a award may be paid out according to the betted amount (S115, S116). Therefore, the number of players who can participate in the game is not limited, it is possible for many players to play the game together, and it may raise the interest factor of the game.

Also, the dealer's cards are pulled out as dealer's hand from each card deck allocated to each terminal, and the player's cards are distributed from the remained cards, therefore it may also be applied to the games such as the Pai Gow Poker and the Black Jack game, in which an award is determined by comparing the dealer's cards and the player's cards.

Furthermore, additional award may be provided to the terminal, to which a card deck including the backside image with a specific design is allocated, according to the game result (S116). It may raise the player's anticipation on receiving a higher award when the card deck is allocated to the player. Therefore, it is possible to provide a card game with higher interest by using plural card decks.

Here, in the conventional card gaming machine, since a game is executed by plural players by using one card deck, players may forecast the dealer's cards by confirming the content of distributed cards with each other. Accordingly, it was difficult to raise the interest of a game which is played by plural players heretofore. Therefore, this kind of problem may be solved by the card gaming machine of the embodiment.

Furthermore, it is possible to increase the number of players who may participate in the game by simply increasing the number of card decks used in the game. Only installing more terminals may easily increase the number of card decks, without changing the basic game program.

Here, the card gaming machine is not limited to the above embodiments.

For example, if a player wins the game on the terminal 4, in which a card deck including a specific backside image is allocated, the pooled amount in the POT may also be paid out instead of paying out an award corresponding to the betted amount.

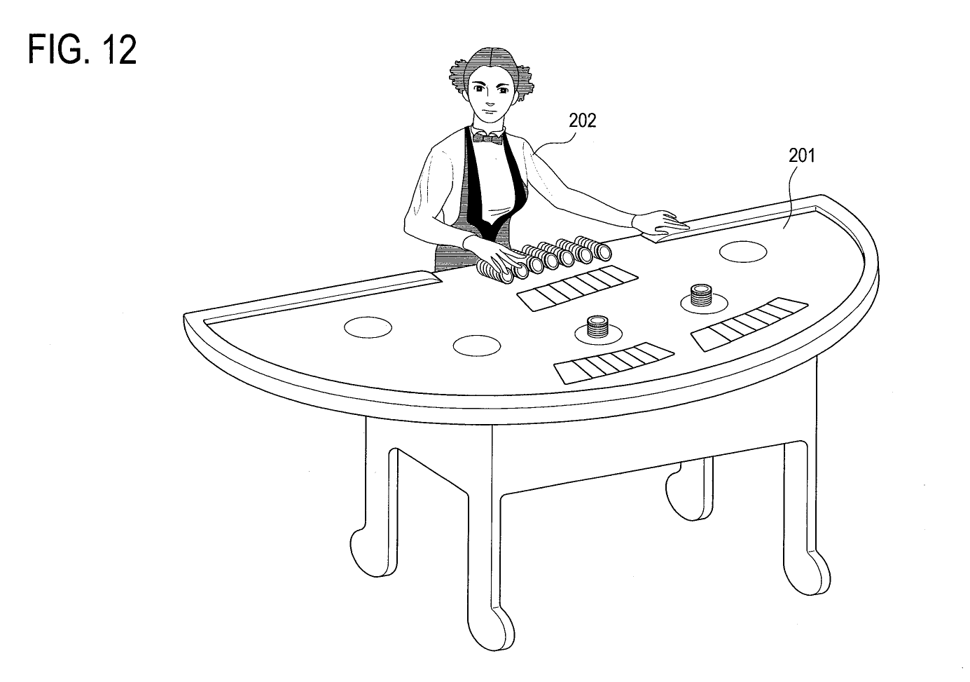

The playing method of the card game according to this embodiment, may also be applied to Pai Gow Poker game (so-called table game), wherein the game is played between the dealer 202 and players (not shown in the figure) on the gaming table 201, as shown in FIG. 12.

In the table game shown in FIG. 12, the dealer 202 may prepare the card decks according to the player number, and may distribute the cards to each player and the dealer respectively on the game table 201. Different card deck may be allocated to each player, and cards may be distributed from the allocated card deck. And players may bet for the game by putting the tips on the predetermined place on the gaming table 201. Here, except for a fact that the dealer distributes the cards directly and the dealer and players allocate the cards directly instead of by image, the concrete gaming method is the same as the gaming method by the preceding card gaming machine 1.

The backside of the cards, which consist the card deck, is printed in different designs. And if the cards, in which the backside image is printed with the specific design show in FIG. 8, are allocated to the player and the player wins the game against the dealer with the above cards, the amount of the award provided to the player becomes higher than usual.

The card gaming machine or the card game playing method according to this embodiment may also be applied to the gaming machine or the card gaming method, in which the Black Jack or the other Poker game is played besides the Pai Gow Poker.

In a case that this embodiment is applied in the Black Jack or Poker and it is accepted at the terminal the input information that the player adds or exchanges player cards, the added cards or exchanged cards are distributed from the remained cards exception for the cards already distributed as player's cards among card deck allocated to the terminal.

Furthermore, in the table game as shown in FIG. 12, when a player declares to order additional cards or exchange player's cards, the additional cards or the exchanged cards may be distributed by the dealer from the remained cards, except for the cards already distributed to a player among the allocated card deck.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A multiplayer card gaming machine comprising:
a display device configured to display player's cards distributed to a player;
a plurality of terminals each of which includes an input device accepting an input from the player; and
a processor programmed to:
(a) provide a plurality of card decks, wherein each card deck containing a plurality of cards necessary for a card game;
(b) respectively allocate one of the card decks to each of the terminals;
(c) distribute the player's cards from the allocated card deck;
(d) progress the card game based on the distributed player's cards and input information input through the input device by the player; and
(e) provide an award to each terminal corresponding to a card game result.

2. The multiplayer card gaming machine according to claim 1, further comprising:
a common display device for displaying a virtual dealer and dealer's cards indicating a hand of the dealer;
wherein the processor distributes the player's cards from remained cards except for the dealer's cards in the one card deck allocated to the terminal, and
wherein the processor progresses the card game based on the dealer's cards, the player's cards and the input information.

3. The multiplayer card gaming machine according to claim 1, wherein when the input information to add cards to or exchange cards with the player's cards is input from the input device, the processor distributes the cards to be added to the player's cards or the cards to be exchanged with the player's cards from remained cards existing after the player's cards are distributed in the one card deck allocated to the terminal.

4. The multiplayer card gaming machine according to claim 1, further comprising:
a memory for storing plural different backside images corresponding to each card deck,
wherein the processor provides an additional award to the terminal to which the card deck of the cards with a predetermined backside image is allocated, corresponding to the card game result.

5. A card gaming method comprising steps of:
providing a plurality of card decks, each of which includes a plurality of cards necessary for a card game;
respectively allocating one of the card decks to each of plural players;
distributing player's cards to each player from the allocated card deck;
progressing the card game based on the distributed player's cards; and
providing an award to each player corresponding to a card game result.

6. The card gaming method according to claim 5, further comprising steps of:
displaying a virtual dealer and dealer's cards indicating a hand of the dealer;
distributing the player's cards from remained cards except for the dealer's cards in the one card deck allocated to the player, and
progressing the card game based on the dealer's cards and the player's cards.

7. The card gaming method according to claim 5, wherein when cards are added to the player's cards or cards are exchanged with the player's cards, the cards are added to the player's cards or the cards are exchanged with the player's cards from remained cards existing after the player's cards are distributed.

8. The card gaming method according to claim 5, wherein each of the card decks has a backside image which is differently designed every card deck, and
wherein an additional award is provided to the player to whom the card deck with a predetermined backside design is allocated, corresponding to the card game result.
